(19) United States
(12) Patent Application Publication
(10) Pub. No.: US 2004/0263905 A1
(43) Pub. Date: Dec. 30, 2004

(54) Print data processing apparatus and data processing apparatus

(75) Inventor: Kenji Okuyama, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Business Technologies, Inc., Tokyo (JP)

(21) Appl. No.: 10/800,213

(22) Filed: Mar. 12, 2004

(30) Foreign Application Priority Data
Jun. 26, 2003 (JP) 2003-182111

(51) Int. Cl. G06F 15/00; H04L 5/16

(52) U.S. Cl. 358/1.16; 358/1.17

(57) ABSTRACT

To provide a print data processing apparatus capable of early releasing a client computer from transmission processing of print data without sacrificing a printing speed, receiving is controlled according to a free space in a receiving buffer 20. Receiving is performed in a high-speed receiving mode while a data amount in the receiving buffer 20 is small, and when the data amount has exceeded a second threshold value 22, the mode is switched to a low-speed receiving mode. When the receiving buffer 20 is full, write processing is started in which the data in the receiving buffer 20 is evacuated into an auxiliary storage device 14, and when the data amount in the receiving buffer 20 is below a third threshold value 23 before completion of the write processing, the write processing is cancelled, and related data in the auxiliary storage device 14 is destroyed, and the receiving in the low-speed receiving mode is resumed. When the write processing is completed, the receiving buffer 20 is emptied, and receiving processing in the high-speed receiving mode is resumed.

### BACKGROUND OF THE INVENTION

1. Field of the Invention

The present invention relates to a print data processing apparatus for sequentially developing print data received from a client computer into image data, and a data processing apparatus for sequentially processing data received from the client computer, and in particular relates to a print data processing apparatus and a data processing apparatus comprising a receiving buffer and an auxiliary storage device for storage places for received data.

2. Description of the Prior Arts

Generally in a printing apparatus, print data is received in a receiving buffer from a data providing device such as a client computer, and a development section sequentially reads the print data from the receiving buffer to develop it into image data, and then a corresponding image is formed and output on a recording paper. When the print data is described in a page-description language (PDL), a relatively long time is required for processing of the received print data to be analyzed and developed into image data. Moreover, the print data described in the page-description language is analyzed page by page, so that even if the print data of another page is received during the analysis of the print data, the analysis of another page has to be kept on standby until the analysis of a current page is completed.

If, due to such a factor, the print data received from the client computer is not read from the receiving buffer or a read rate is decreased, the client computer will be restrained for a long time due to transmission processing of the print data.

Therefore, a technique has been proposed in which, when the receiving buffer is full, the print data in the receiving buffer is stored in an auxiliary storage device such as a hard disk drive to generate a free space in the receiving buffer, thereby early releasing the client computer from the transmission processing of the print data (e.g., refer to Japanese Patent Publication Laid-open No. 2000-99291 and Japanese Patent Publication Laid-open No. 2000-259373.)

As described above, the print data coming from the client computer is stored in the high capacity auxiliary storage device, so that the client computer can be early released from the transmission processing of the print data. However, a data reading/writing speed of the auxiliary storage device such as the hard disk drive is lower than that of a semiconductor memory used for the receiving buffer. Further, in a conventional configuration, in spite of such low speed performance, if the receiving buffer has run out of the free space, a subsequent storage location is fixedly switched to the auxiliary storage device, and once the print data is saved in the auxiliary storage device, the print data in the auxiliary storage device is always used, thus inefficiently switching the receiving buffer and the auxiliary storage device.

Especially, the print data is concurrently written into and read from the auxiliary storage device if printing is conducted via the auxiliary storage device, so that, for example, when the hard disk drive is used as the auxiliary storage device, a head of the hard disk drive moves frequently, which could significantly decrease the data reading/writing speed. As a result, there has been a problem that processing time for development into the image data is increased to further decrease printing speed.

### SUMMARY OF THE INVENTION

The present invention has been made in view of such problems posed by the prior art, and has an object to provide a print data processing apparatus capable of early releasing a client computer from transmission processing of print data without sacrificing a printing speed, and a data processing apparatus capable of early releasing the client computer from data transmission processing without sacrificing a speed of processing received data.

The spirit of the present invention to accomplish such an object is in each aspect of the invention as follows:

A print data processing apparatus according to a first aspect of the invention comprises: a receiver for receiving print data; a receiving buffer for storing the received print data; a receiving controller for stopping receiving processing of the print data performed by the receiver when a free space in the receiving buffer has run out, and resuming the receiving processing of the print data performed by the receiver when the free space in the receiving buffer is above the predetermined value; auxiliary storage device which can store the print data; write controller for starting write processing to write the print data stored in the receiving buffer into the auxiliary storage device when the free space in the receiving buffer has run out, and stopping the write processing when the free space in the receiving buffer is above a predetermined value before completion of writing; and a developing unit for reading the print data from the receiving buffer or the auxiliary storage device to develop the print data into image data, wherein when the print data which has finished with the write processing is present in the auxiliary storage device, the developing unit reads the print data from the auxiliary storage device to develop the print data into image data.

According to the invention described above, when the receiving buffer (20) is full of print data, the write processing is started wherein receiving is suspended, and the print data in the receiving buffer (20) is transferred to and stored in the auxiliary storage device (14). When the developing means (13) is activated during implementation of the write processing and a predetermined amount or more of free space is generated in the receiving buffer (20) before completion of the write processing, the write processing into the auxiliary storage device (14) is cancelled, and the print data which is stored partway is destroyed from the auxiliary storage device (14), and then receiving is resumed. On the other hand, when the write processing is completed before the predetermined amount or more of free space is generated in the receiving buffer (20), a corresponding amount of free space is produced in the receiving buffer (20) to resume receiving. For example, when all the print data in the receiving buffer (20) is stored, the receiving buffer (20) is emptied.

In this way, even when the receiving buffer (20) once becomes full to start storage into the auxiliary storage device (14), if the predetermined amount or more of free space is generated in the receiving buffer (20) before the completion of the write processing, use of the auxiliary storage device (14) is cancelled so that transfer of print data is continued by the receiving buffer (20). As a result, development ptocessing is less often performed via the auxiliary storage device (14), and overhead associated with reading/writing of the auxiliary storage device (14) is reduced, and yet the printing speed is prevented from being decreased.

On the other hand, when the predetermined amount or more of free space is not generated in the receiving buffer (20) before the completion of the write processing, the write processing of the print data into the auxiliary storage device (14) is completed to generate a corresponding amount of free space in the receiving buffer (20), so that the client computer can be early released from the transmission processing of the print data. Moreover attention is focused only on an amount of data in the receiving buffer (20) to control writing into the auxiliary storage device (14), thereby requiring no complicated condition judgment corresponding to various states for a system, facilitating the mounting of the system onto a printing apparatus or the like, and allowing reuse of the system for different models.

A print data processing apparatus according to a second aspect of the invention comprises: a receiver for receiving print data; a receiving buffer for storing the received print data; a receiving controller for switching receiving processing of the print data performed by the receiver to a first receiving mode, a second receiving mode in which the receiving processing is slower than in the first receiving mode, and a suspend mode which suspends the receiving processing; auxiliary storage device which can store the print data; write controller for starting write processing to write the print data stored in the receiving buffer into the auxiliary storage device when a free space in the receiving buffer has run out, and canceling the write processing when the free space in the receiving buffer is above a predetermined value before completion of writing; and developing means for reading the print data from the receiving buffer or the auxiliary storage device to develop the print data into image data, wherein when an amount of print data stored in the receiving buffer is below a first threshold value, the receiving controller sets the receiving processing into the first receiving mode, and when the amount of print data stored in the receiving buffer has exceeded a second threshold value, the receiving controller sets the receiving processing into the second receiving mode, and when the free space in the receiving buffer has run out, the receiving controller sets the receiving processing into the suspend mode, and when the free space in the receiving buffer is above a predetermined amount, the receiving processing of the print data performed by the receiver is resumed; and when the print data which has finished with the write processing is present in the auxiliary storage device, the developing unit reads the print data from the auxiliary storage device to develop the print data into image data.

According to the invention described above, the receiving processing is switched to a high-speed receiving mode or a low-speed receiving mode depending on the amount of print data stored in the receiving buffer (20) (i.e., amount of free space in the receiving buffer (20)). Further, when the receiving buffer (20) is full of print data, the write processing is started wherein the print data in the receiving buffer (20) is transferred to and stored in the auxiliary storage device (14), and when the predetermined amount or more of free space is generated in the receiving buffer (20) before completion of the write processing, the write processing into the auxiliary storage device (14) is cancelled, and the print data which is stored partway is destroyed from the auxiliary storage device (14), and then receiving is resumed. On the other hand, when the write processing is completed, a corresponding amount of free space is generated in the receiving buffer (20) to resume receiving.

In this way, control is performed in accordance with the amount of data in the receiving buffer (20), so that even with a varying relationship between a speed at which the developing means (13) reads the print data from the receiving buffer (20) and a speed at which the print data is received from a client computer or the like, the receiving processing and developing processing always keep the best balance to achieve efficient processing. Especially, the write processing is stopped when writing into the auxiliary storage device (14) is once started but then judged to be unnecessary, and thus overhead is reduced by way of the auxiliary storage device (14).

Furthermore, attention is focused only on the amount of data in the receiving buffer (20) to control writing into the auxiliary storage device (14), thereby requiring no complicated condition judgment corresponding to various states for the system, facilitating the mounting of the system onto the printing apparatus or the like, and allowing the reuse of the system for different models.

A print data processing apparatus according to a third aspect of the invention comprises: a receiver for receiving data; a receiving buffer for storing the received data; receiving controller for stopping receiving processing of the data performed by the receiver when a free space in the receiving buffer has run out, and resuming the receiving processing of the print data performed by the receiver when the free space in the receiving buffer is above a predetermined amount; auxiliary storage device which can store the data; write controller for starting write processing to write the data stored in the receiving buffer into the auxiliary storage device when the free space in the receiving buffer has run out, and canceling the write processing when the free space in the receiving buffer is above a predetermined value before completion of writing; and processing unit for reading the print data from the receiving buffer or the auxiliary storage device to process the print data, wherein when the data which has finished with the write processing is present in the auxiliary storage device,/the processing unit reads the data from the auxiliary storage device to process the data.

According to the invention described above, when the receiving buffer (20) is full of data, the write processing is started wherein receiving is suspended, and the data stored in the receiving buffer (20) is transferred to and stored in the auxiliary storage device (14). When the processing means is activated during implementation of the write processing and a predetermined amount or more of free space is generated in the receiving buffer (20) before completion of the write processing, the write processing into the auxiliary storage device (14) is cancelled, and the data which is stored partway is destroyed from the auxiliary storage device (14), and then receiving is resumed. On the other hand, when the write processing is completed before the predetermined amount or more of free space is generated in the receiving buffer (20), a free spade corresponding to the data stored in the auxiliary storage device (14) in this write processing is generated in the receiving buffer (20).

In this way, even when the receiving buffer (20) once becomes full to start storage into the auxiliary storage device (14), if the predetermined amount or more of free space is generated in the receiving buffer (20) before the completion of the write processing, use of the auxiliary storage device (14) is stopped so that data transfer by use of the receiving buffer (20) is continued. As a result, processing is less often performed via the auxiliary storage device (14), and the overhead associated with reading/writing of the auxiliary storage device (14) is reduced, and yet the printing speed is prevented from being decreased. When the write processing is completed, the write processing of the data into the auxiliary storage device (14) is completed to generate a corresponding amount of free space in the receiving buffer (20), so that the client computer can be early released from the transmission processing of the data.

### BRIEF DESCRIPTION OF THE DRAWINGS

FIG. 1 is a state transition diagram at a receiving end in a print data processing apparatus according to an embodiment of the present invention;

FIG. 2 is a block diagram showing a schematic configuration of the print data processing apparatus according to the embodiment of the present invention;

FIG. 3 is a state transition diagram of a developing end in the print data processing apparatus according to the embodiment of the present invention;

FIG. 4 is an explanatory view showing one example of data amount transition in a receiving buffer when returning from a low-speed receiving mode to a high-speed receiving mode;

FIG. 5 is an explanatory view showing one example of data amount transition in the receiving buffer when the receiving buffer has become full, and then the data amount is below a third threshold value before completion of write processing into an auxiliary storage device; and

FIG. 6 is an explanatory view showing one example of data amount transition in the receiving buffer when the write processing into the auxiliary storage device is completed after the receiving buffer has become full.

### DETAILED DESCRIPTION OF THE PREFERRED EMBODIMENT

The present invention will hereinafter be described in reference to the accompanying drawings showing an embodiment.

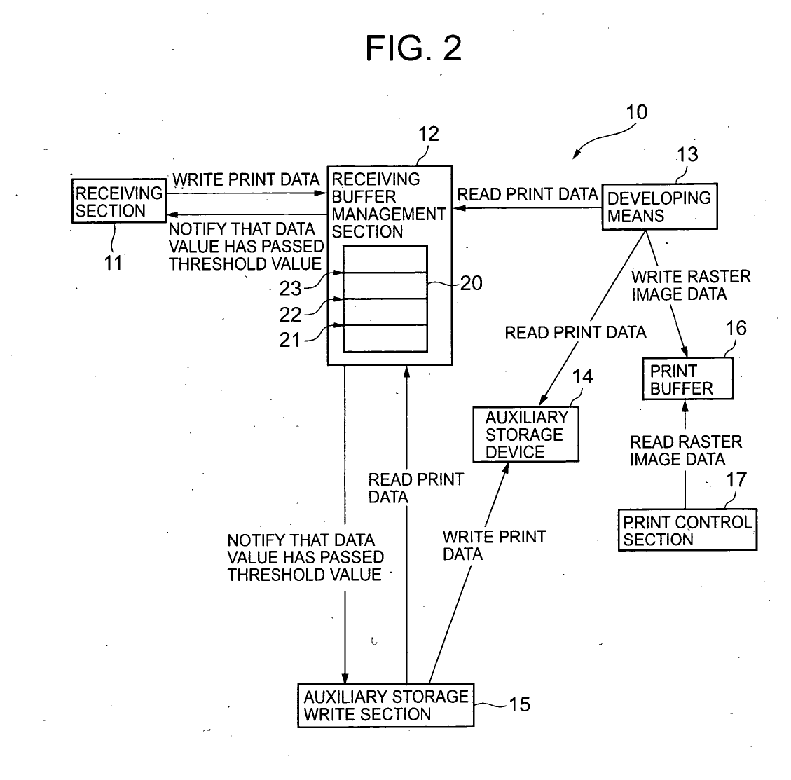

FIG. 2 shows a functional configuration of a print data processing apparatus 10 according to the embodiment of the present invention. The print data processing apparatus 10 has a function as a printer or printing apparatus to receive print data from a print data transmission device such as a client computer via a network such as a LAN (local area network), and develop it into image data, and then form and output a corresponding image on a recording paper.

The print data processing apparatus 10 comprises circuitry having a CPU (central processing unit), a ROM (read-only memory) and a RAM (random access memory) as major components, and comprises functions as a receiving section 11, a receiving buffer 20, a receiving buffer management section 12, a developing means 13, an auxiliary storage device 14, an auxiliary storage write section 15, a print buffer 16 and a print control section 17. Predetermined areas on the RAM are allocated to the receiving buffer 20 and the print buffer 16.

The receiving section 11 comprises a function to receive the print data from the print data transmission device such as the client computer through a network, and a function to write the received print data into the receiving buffer 20. Receiving processing of the print data includes a high-speed receiving mode, a low-speed receiving mode in which the receiving processing is slower than in the high-speed receiving mode, and a suspend mode which suspends the receiving processing. The receiving section 11 functions as a receiving control means to switch these modes. For example, when a real-time operating system is used, switching to the low-speed receiving mode is accomplished by giving low priority to a task associated with the receiving processing, or by keeping the receiving section 11 on standby in any way.

The receiving buffer management section 12 functions to manage the receiving buffer 20 disposed in the predetermined area on the RAM. The receiving buffer management section 12 stores a first threshold value 21 to be compared with an mount of print data stored in the receiving buffer 20, a second threshold value 22 and a third threshold value 23. These threshold values 21 to 23 may be predetermined fixed values, or may be values that can be reset later. The receiving buffer management section 12 constantly recognizes the data amount in the receiving buffer 20, and comprises a function to inform various processing sections (e.g., sections which control the priority of each task) including the receiving section 11 and the auxiliary storage write section 15 that the data amount in the receiving buffer 20 has exceeded the threshold values 21 to 23, that the data amount in the receiving buffer 20 is below the threshold values 21 to 23, and that the receiving buffer 20 is full (has no free space).

When the receiving buffer has run out of free space, processing after suspension of the receiving processing or the like may be performed, judging that no free space exists, not only in the case where the free space is completely 0, but also in the case where the free space is less than a predetermined value well in advance.

The auxiliary storage device 14 comprises a high capacity storage device such as a hard disk drive, and can save the print data. The auxiliary storage write section 15 functions as a write control means, and has a function to perform write processing for writing the print data in the receiving buffer 20 into the auxiliary storage device 14 in accordance with a notification from the receiving buffer management section 12. It also has a function to cancel the write processing halfway, and to destroy the print data and its related data, which have been written in the current write processing, from the auxiliary storage device 14 before the cancellation. Further, when the write processing is completed, the receiving buffer management section 12 will be notified accordingly. This notification includes the amount of written data.

The developing means 13 functions to read the print data from the receiving buffer management section 12 or the auxiliary storage device 14, and analyze it and develop it into raster image data. The developing means 13 complies with various kinds of page-description languages as well as character data. The print buffer 16 is disposed on the RAM, and stores the raster image data developed by the developing means 13. The print control section 17 functions to read the raster image data in the print buffer 16, and form and output a corresponding image on a recording paper.

Next, an operation of the print data processing apparatus 10 having the configuration described above will be described.

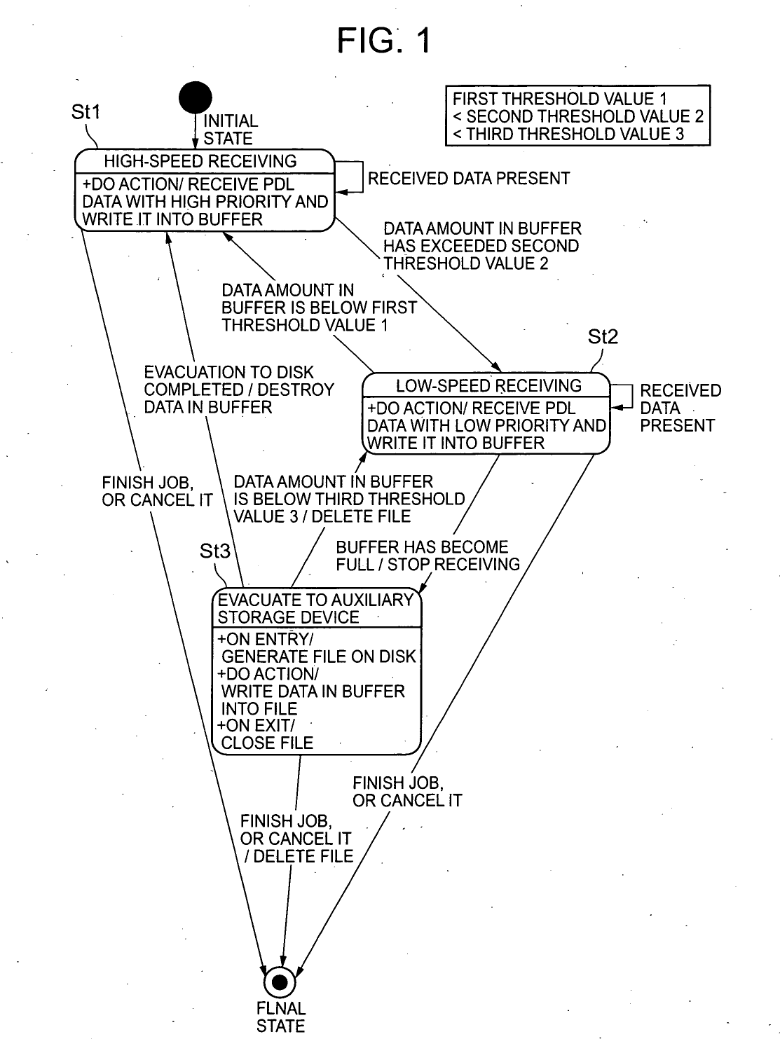

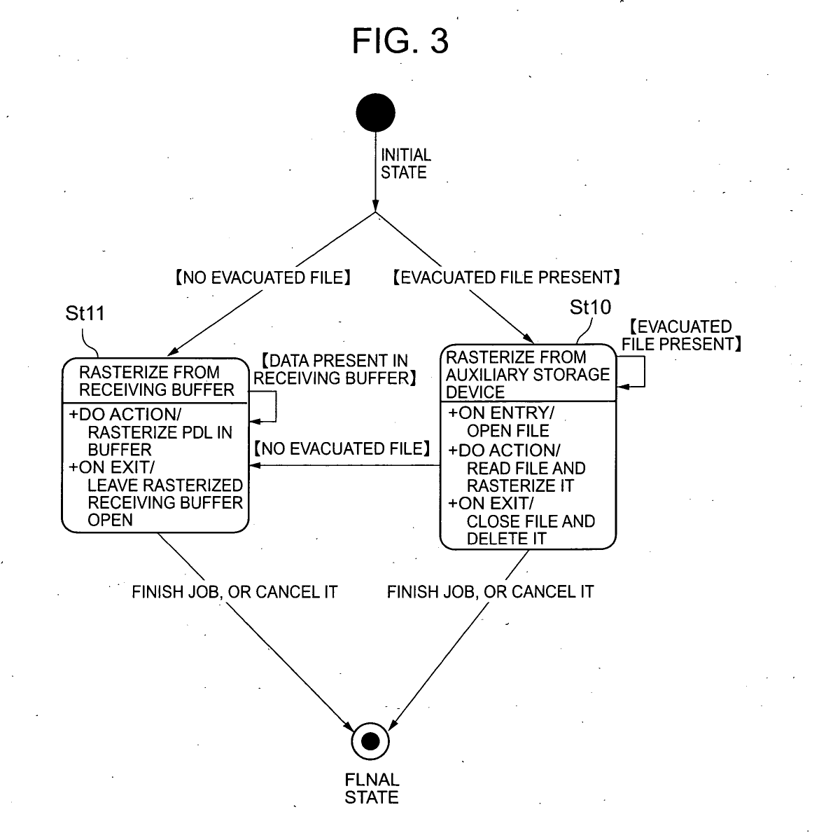

FIG. 1 shows a state transition of a receiving end, and FIG. 3 shows a state transition a developing end. Since the data amount in the receiving buffer 20 is below the first threshold value 21 (normally no data) at the start of receiving, the receiving processing is performed in the high-speed receiving mode (FIG. 1, St1).

Subsequently, when the data amount in the receiving buffer 20 has increased and the receiving buffer management section 12 notifies the receiving section 11 that the data amount has exceeded the second threshold value 22, the receiving section 11 decreases the priority of the receiving processing, and transits into the low-speed receiving mode (St2). In the low-speed receiving mode, if the low priority of the receiving processing brings the developing means 13 into an operable state, processing of the developing means 13 is given priority over processing of the receiving section 11, and the data amount in the receiving buffer 20 tends to be decreased.

As a result of switching into the low-speed receiving mode, the data amount in the receiving buffer 20 is decreased, and the receiving buffer management section 12 notifies the receiving section 11 that the data amount in the receiving buffer 20 is below the first threshold value 21, and then the receiving processing will again be in the high-speed receiving mode (St1). In this way, priority is controlled by switching the low-speed receiving mode and high-speed receiving mode in accordance with the data amount in the receiving buffer 20. For example, when the real-time operating system is used and mounted, the number of task switches can be smaller than when the priority is not controlled, thereby reducing overhead associated with the task switch.

In a state of the low-speed receiving mode (St2), when the receiving buffer 20 is full (has no free space), it transits to an evacuation state (St3) to the auxiliary storage device 14. In other words, when the receiving buffer management section 12 notifies the receiving section 11 that the receiving buffer 20 is full (has no free space), the receiving section 11 suspends the receiving processing. At the same time, the receiving buffer management section 12 notifies the auxiliary storage write section 15 that the receiving buffer 20 is full, and the auxiliary storage write section 15, in response to this, starts the write processing to write the print data (PDL data) in the receiving buffer 20 into the auxiliary storage device 14.

The receiving buffer 20 becomes full and transits to the evacuation state (St3) in spite of the low-speed receiving mode, and this is presumably due to the fact that developing processing of the developing means 13 is operating at a very low speed or stopped. In such a situation, a user has a greater advantage by quickly finishing receiving and early releasing the client computer from transmission processing of the print data, rather than giving priority to a speed after the developing processing. Therefore, the write processing is started in which the print data in the receiving buffer 20 is evacuated to the auxiliary storage device 14 so that the receiving can be resumed. In the write processing, the print data stored in the receiving buffer 20 may be collectively written, and when the receiving buffer 20 is divided into blocks and managed, the print data may be written on a block basis. In addition, it will be-easier to manage data if a file system is constructed on the auxiliary storage device 14.

If the receiving buffer management section 12 notifies the auxiliary storage write section 15 that the data amount in the receiving buffer 20 is below the third threshold value 23 before the completion of the write processing, the auxiliary storage write section 15 will cancel the write processing into the auxiliary storage device 14, and destroys the related data in the auxiliary storage device 14 so that the current write processing is erased.

It should be understood that completion of writing is not limited to a case in which all the print data in the receiving buffer 20 has been written into the auxiliary storage device 14, but may be a case in which a partial unit in the receiving buffer 20, for example, data on a print job unit or data on a file unit has been written.

The receiving section 11 is also notified at the same time that the data amount in the receiving buffer 20 is below the third threshold value 23, and the receiving section 11, in response to this, changes to the low-speed receiving mode to resume the receiving processing. The reason why the data amount in the receiving buffer 20 is below the third threshold value 23 before the completion of write processing in this way presumably lies in the fact that the developing processing which had been at the low speed or stopped until then has restored to a high-speed operating state. Therefore, evacuation to the auxiliary storage device 14 whose data input/output speed is low is immediately cancelled, and the state is again switched such that the print data is transferred to the developing means 13 only via the receiving buffer 20, thereby preventing the developing processing to become unnecessarily slow.

When the data amount in the receiving buffer 20 is not below the third threshold value 23 and the write processing into the auxiliary storage write section 15 is completed, the print data in the receiving buffer 20 is destroyed because it is not necessary. Then, the receiving processing is resumed to continue receiving. Herein, the receiving processing is resumed after transiting to the high-speed receiving mode.

As shown in FIG. 3, if the print data which has finished with the write processing is present on the auxiliary storage device 14 (St10), the developing means 13 reads it, and develops it into the raster image data. Subsequently, the developed print data is deleted from the auxiliary storage device 14. If the print data which has finished with the write processing is not present on the auxiliary storage device 14 (St11), the print data is read from the receiving buffer 20 by priority, so as to develops it into the raster image data.

In addition, while the write processing into the auxiliary storage device 14 is started and completed, the developing means 13 may read the print data from the receiving buffer 20 and develop it within a range in which the data amount in the receiving buffer 20 does not lower below the third threshold value 23. In such a case, as a head portion of the print data evacuated to the auxiliary storage device 14 has already been developed, it is necessary to adjust and align a starting position for the developing processing in the print data read from the auxiliary storage device 14 in order to avoid redundant development. For example, the data amount read from the receiving buffer 20 by the developing means 13 during implementation of the write processing can be stored somewhere, and referred to later to adjust the starting position for the developing processing.

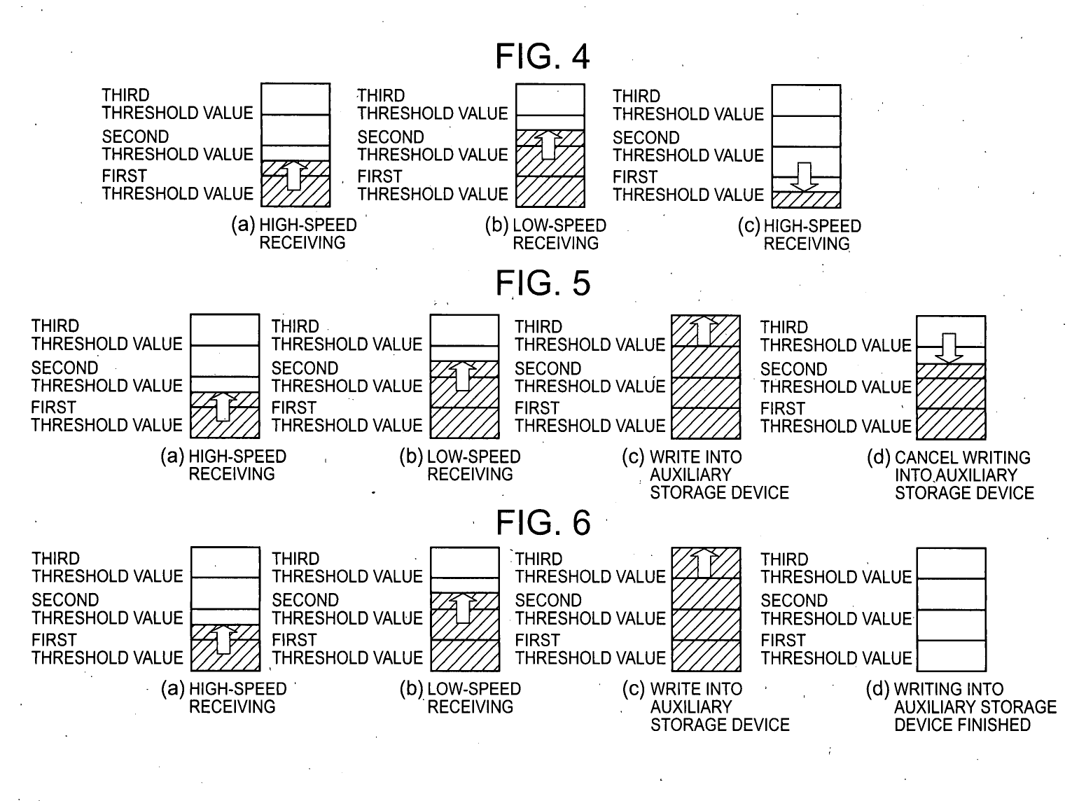

FIG. 4 to FIG. 6 show various examples of the transition of the data amount in the receiving buffer 20 in connection with the operation described above. FIG. 4(a) shows a state shortly after the start of receiving in which the data amount in the receiving buffer 20 has not yet exceeded the second threshold value 22, and the receiving is performed in the high-speed receiving mode. FIG. 4(b) shows a state in which the data amount in the receiving buffer 20 has exceeded the second threshold value 22, and the receiving is performed switching into the low-speed receiving mode. FIG. 4(c) shows a subsequent state in which the data amount in the receiving buffer 20 is below the first threshold value 21, and the high-speed receiving mode is set again.

FIG. 5(a) shows a state shortly after the start of receiving in which the data amount in the receiving buffer 20 has not exceeded the second threshold value 22, and the receiving is performed in the high-speed receiving mode. FIG. 5(b) shows a state in which the data amount in the receiving buffer 20 has exceeded the second threshold value 22, and the receiving processing is performed in the low-speed receiving mode. FIG. 5(c) shows a state in which the receiving buffer 20 is full, and the receiving is suspended, and the write processing into the auxiliary storage device 14 is started. FIG. 5(d) shows a state in which the developing means 13 reads the print data from the receiving buffer 20 and develops it before the completion of write processing into the auxiliary storage device 14, and the data amount in the receiving buffer 20 is below the third threshold value 23. If the data amount is below the third threshold value 23 before the completion of write processing, the write processing into the auxiliary storage device 14 will be cancelled, and the related data on the auxiliary storage device 14 is destroyed to resume the receiving processing.

FIG. 6(a) shows a state in the high-speed receiving mode shortly after the start of receiving. Subsequently, if the data amount in the receiving buffer 20 has exceeded the second threshold value 22 as shown in FIG. 6(b), the mode is switched to the low-speed receiving mode. If the receiving buffer 20 becomes full as shown in FIG. 6(c), the receiving is suspended, and the write processing into the auxiliary storage device 14 is started. FIG. 6(d) shows a state in which the write processing into the auxiliary storage device 14 is completed while the data amount in the receiving buffer 20 is not below the third threshold value 23, and the data in the receiving buffer 20 is destroyed, and the receiving buffer 20 has a free space and is empty. Since the data amount in the receiving buffer 20 is below the first threshold value 21, the receiving processing is resumed in the high-speed receiving mode.

While the embodiment of the present invention has been described above in connection with the drawings, specific configurations and embodiments are not limited thereto, and modification and addition without departing from the spirit of the present invention fall in the present invention. For example, in the embodiment, all the data in the receiving buffer 20 is evacuated into the auxiliary storage device 14 in the write processing into the auxiliary storage device 14, but only part of the data may be evacuated. When only part of the data is evacuated, a corresponding amount of data in the receiving buffer 20 may be destroyed and a free space may be generated therein. In addition, when only part of the data is evacuated, the receiving processing may be resumed in the low-speed receiving mode after the completion of write processing. Further, transition to the high-speed receiving mode or to the low-speed receiving mode can be switched depending on the amount of free space generated by the completion of write processing.

The print data processing apparatus comprising a function to receive the print data and develop it into the image data has been described as an example in the embodiment, but the data to be received may not be the print data, and the processing of the received data in not limited to the development into the image data. In other words, the data processing apparatus in which processing means subjects the received data to predetermined processing will also benefit from the present invention.

The predetermined processing corresponds to relatively time-consuming processing such as data analysis, edition of various data, and encryption.

In addition, the three threshold values are set in such a relationship as the first threshold value 21<the second threshold value 22<the third threshold value 23 in the embodiment, but the third threshold value 23 does not need to be higher than the second threshold value 22. The third threshold value 23 may be a value that generates a certain amount of free space in the receiving buffer 20, and may be set to an optional value without correlation with the other threshold values. Further, the processing is optimized by switching the receiving processing to the high-speed receiving mode and the low-speed receiving mode in the embodiment, but it is possible to dispense with a receiving speed switching function, and what is needed to be provided is the function to suspend receiving when the receiving buffer 20 is full.

According to the print data processing apparatus and the data processing apparatus of the present invention, even when the receiving buffer once becomes full and storage into the auxiliary storage device is started, if a predetermined amount or more of free space is generated in the receiving buffer before the completion of the write processing, use of the auxiliary storage device is stopped so that transfer of data is continued by the receiving buffer. This makes it possible to early release the client computer from the transmission processing of the data without sacrificing the processing speed and printing speed. In other words, the development processing or the like is less often performed via the auxiliary storage device, and thus overhead associated with the reading/writing of the auxiliary storage device is reduced, and the processing speed and printing speed are prevented from being decreased. Further, when the write processing into the auxiliary storage device is completed, a free space is generated in the receiving buffer to resume receiving processing, so that the client computer can be early released from the transmission processing of the data.

Furthermore, in the print data processing apparatus that comprises the function to switch the receiving processing to the high-speed receiving mode and the low-speed receiving mode in accordance with the amount of print data stored in the receiving buffer, even with a varying relationship between a speed at which the developing means reads the print data from the receiving buffer and a speed at which the print data is received from the client computer, the receiving processing and developing processing always keep the best balance to achieve efficient processing.

What is claimed is:

1. A print data processing apparatus comprising:
a receiver for receiving print data;
a receiving buffer for storing the received print data;
a receiving controller for stopping receiving processing of the print data performed by the receiver when a free space in the receiving buffer has run out, and resuming the receiving processing of the print data performed by the receiver when the free space in the receiving buffer is above the predetermined value;
auxiliary storage device which can store the print data;
a write controller for starting write processing to write the print data stored in the receiving buffer into the auxiliary storage device when the free space in the receiving buffer has run out, and stopping the write processing when the free space in the receiving buffer is above a predetermined value before completion of writing; and
a developing unit for reading the print data from the receiving buffer or the auxiliary storage device to develop the print data into image data,
wherein when the print data which has finished with the write processing is present in the auxiliary storage device, the developing unit reads the print data from the auxiliary storage device to develop the print data into image data.

2. The print data processing apparatus according to claim 1, wherein when the write processing is cancelled, the write controller destroys the print data in the auxiliary storage device.

3. The print data processing apparatus according to claim 1, wherein when the write processing is completed, the write controller empties the space of the receiving buffer where the print data written into the auxiliary storage device in this write processing has been stored.

4. The print data processing apparatus according to claim 1, wherein when the print data which has finished with the write processing is present in the auxiliary storage device, the developing unit reads the print data in order of writing.

5. The print data processing apparatus according to claim 1, wherein after reading the print data, the developing means destroys the print data in the auxiliary storage device.

6. The print data processing apparatus according to claim 1, wherein the auxiliary storage device is a hard disk drive.

7. A print data processing apparatus comprising:
a receiver for receiving print data;
a receiving buffer for storing the received print data;
a receiving controller for switching receiving processing of the print data performed by the receiver to a first receiving mode, a second receiving mode in which the receiving processing is slower than in the first receiving mode, and a suspend mode which suspends the receiving processing;
auxiliary storage device which can store the print data;
write controller for starting write processing to write the print data stored in the receiving buffer into the auxiliary storage device when a free space in the receiving buffer has run out, and canceling the write processing when the free space in the receiving buffer is above a predetermined value before completion of writing; and
developing unit for reading the print data from the receiving buffer or the auxiliary storage device to develop the print data into image data,
wherein when an amount of print data stored in the receiving buffer is below a first threshold value, the receiving controller sets the receiving processing into the first receiving mode, and when the amount of print data stored in the receiving buffer has exceeded a second threshold value, the receiving controller sets the receiving processing into the second receiving mode, and when the free space in the receiving buffer has run out, the receiving controller sets the receiving processing into the suspend mode, and when the free space in the receiving buffer is above a predetermined amount, the receiving processing of the print data performed by the receiver is resumed; and
when the print data which has finished with the write processing is present in the auxiliary storage device, the developing unit reads the print data from the auxiliary storage device to develop the print data into image data.

8. The print data processing apparatus according to claim 7, wherein when the write processing is cancelled, the write controller destroys the print data in the auxiliary storage device.

9. The print data processing apparatus according to claim 7, wherein when the write processing is completed, the write controller empties the space of the receiving buffer where the print data written into the auxiliary storage device in this write processing has been stored.

10. The print data processing apparatus according to claim 7, wherein when the print data which has finished with the write processing is present in the auxiliary storage device, the developing unit reads the print data in order of writing.

11. The print data processing apparatus according to claim 7, wherein after reading the print data, the developing unit destroys the print data in the auxiliary storage device.

12. The print data processing apparatus according to claim 7, wherein the auxiliary storage device is a hard disk drive.

13. The print data processing apparatus according to claim 7, wherein when the receiving processing by the receiver is resumed, it is resumed in the first receiving mode or the second receiving mode, depending on the amount of print data stored in the receiving buffer.

14. A print data processing method comprising the steps of:
receiving print data, and storing the print data in a receiving buffer;
reading the print data from the receiving buffer to develop the print data into image data;
stopping receiving processing of the print data performed by receiving device when a free space in the receiving buffer has run out, and starting writing of the print data stored in the receiving buffer into an auxiliary storage device; and
when the free space of the receiving buffer reaches a predetermined amount or more before completion of the write processing into the auxiliary storage device, canceling the writing, and resuming the receiving processing of the print data performed by the receiving device.

15. The print data processing method according to claim 14, having a step of, when the print data which has finished with the write processing is present in the auxiliary storage device, reading the print data from the auxiliary storage device to develop the print data into image data.

16. The print data processing method according to claim 14, wherein when the write processing is cancelled, the print data in the auxiliary storage device is destroyed.

17. The print data processing method according to claim 14, wherein when the write processing is completed, the space of the receiving buffer where the print data written into the auxiliary storage device in this write processing has been stored is emptied.

18. The print data processing method according to claim 14, wherein when the print data which has finished with the write processing is present in the auxiliary storage device, the print data is read in order of writing.

19. The print data processing method according to claim 14, wherein after the print data is read, the print data in the auxiliary storage device is destroyed.

20. A print data processing apparatus comprising:
a receiver for receiving data;
a receiving buffer for storing the received data;
a receiving controller for stopping receiving processing of the data performed by the receiver when a free space in the receiving buffer has run out, and resuming the receiving processing of the data performed by the receiver when the free space in the receiving buffer is above a predetermined amount;
auxiliary storage device which can store the data;
write controller for starting write processing to write the data stored in the receiving buffer into the auxiliary storage device when the free space in the receiving buffer has run out, and canceling the write processing when the free space in the receiving buffer is above a predetermined value before completion of writing; and
processing means for reading the data from the receiving buffer or the auxiliary storage device to process the print data,
wherein when the data which has finished with the write processing is present in the auxiliary storage device, the processing means reads the data from the auxiliary storage device to process the data.
